(19) United States
(12) Patent Application Publication
(10) Pub. No.: US 2004/0059534 A1
(43) Pub. Date: Mar. 25, 2004

(54) Recording medium residual amount detecting device, image forming apparatus provided with device, and program for operating computer

(75) Inventor: Hidetoshi Nojiri, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/656,204

(22) Filed: Sep. 8, 2003

(30) Foreign Application Priority Data
Apr. 3, 2002 (JP) 2002-101372
Apr. 1, 2003 (WO) PCT/JP03/04167

(51) Int. Cl. G01M 7/00

(52) U.S. Cl. 702/115

(57) ABSTRACT

A residual amount detecting device for detecting information concerning a residual amount of recording medium. The residual amount detecting device includes an external force applying unit that applies an external force to a recording medium group in a thickness direction thereof and an external force detecting unit that detects the external force applied to the recording medium group. The external force detecting unit is disposed such that the recording medium group is set in a position between the external force applying unit and the external force detecting unit. With the residual amount detecting device, it is possible to detect information concerning the residual amount of a recording medium even before using up the recording medium group stacked in an image forming apparatus.

This application is a continuation of International Application No. PCT/JP03/04167, filed on Apr. 1, 2003, which claims the benefit of Japanese Patent Application No. 2002-101372 filed Apr. 3, 2002.

### BACKGROUND OF THE INVENTION

1. Field of the Invention

The present invention relates to a residual amount detecting device for detecting information concerning a residual amount of recording media, an image forming apparatus provided with a residual amount detecting device, and a program for operating a computer connected directly or indirectly with the image forming apparatus.

2. Reated Background Art

Up to now, as image forming apparatuses used for a printer, a copying machine, a facsimile, and a multifunctional machine having those functions, and an output apparatus of a work station and electronic equipment including a computer etc, there are enumerated a laser beam printer (LBP), an inkjet printer (IJP), a thermal printer, and the like. Such image forming apparatuses can form an image on a recording medium inclusive of paper and an OHP film based on image information.

The image forming apparatuses are generally provided with a recording medium feeder (SF: sheet feeding apparatus) or a recording medium cassette so that the apparatus can have plural sheets of the recording medium stacked therein. However, when images are to be outputted on plural sheets, all recording media in the SF may be consumed before a user completes image formation for a desired number of sheets.

For example, a case is considered where 10 printing sheets are stacked in the SF. In this case, even when the user issues a command for outputting images on 100 sheets through a computer, after finishing the 10th printing, the image forming apparatus notifies the user that there is no sheet left for the 11th printing. Then, the user receiving the notification needs to actually go to the apparatus to replenish the recording media.

However, such a system is inconvenient, in which notification is performed after consuming all the printing sheets, because the user has to always pay his/her attention whether or not the printing sheets are sufficiently provided to the image forming apparatus during the printing operation.

In the days to come, in particular, it is expected that a single image forming apparatus is shared among a number of users and host devices through a network more often. Therefore, it is difficult for each user himself to figure out the exact remaining number of sheets being stacked.

### SUMMARY OF THE INVENTION

In view of the above, the present invention has been made, and an object thereof is to provide a residual amount detecting device capable of detecting information concerning a residual amount of recording media even before consuming the recording media stacked in an SF or a recording medium cassette. In addition, another object of the present invention is to provide an image forming apparatus capable of outputting information concerning the residual amount of recording media irrespective of the presence or absence of the recording media stacked in the image forming apparatus. Also, another object of the present invention is to detect presence or absence of the recording media.

A residual amount detecting device for detecting information concerning a residual amount of a recording medium according to the present invention, includes: external force applying means that applies an external force to a recording medium group in a thickness direction thereof; and external force detecting means that detects the external force applied to the recording medium group, in which the external force detecting means is disposed such that the recording medium group is set in a position between the external force applying means and the external force detecting means.

The external force applying means and the external force detecting means can be composed of, for example, a first electrode capable of being in contact with a front surface of the recording medium group and a second electrode capable of being in contact with a rear surface of the recording medium group, as well as voltage applying means for applying a voltage between the first electrode and the second electrode.

In the recording medium residual amount detecting device, the information concerning the residual amount of the recording medium may be detected by comparing a signal stored in advance in a storage circuit corresponding to the residual amount, with a signal detected by the external force detecting means.

The residual amount detecting device may further include warning means that issues, when a remaining number of the recording medium is equal to or less than a predetermined value, a warning that the remaining number is equal to or less than the predetermined value.

It should be noted here that the image forming apparatus specified in the present invention is adapted to perform printing (or thermal transfer) of characters, graphics, and the like on paper (plain paper, glossy paper, and high quality dedicated paper, for instance) or OHP films serving as the recording medium.

An image forming apparatus according to the present invention includes detecting means that detects information concerning a residual amount of a recording medium stacked in the image forming apparatus, in which the information is outputted as electronic information irrespective of the presence or absence of the recording medium.

Note that the information concerning the residual amount of the recording medium is information of a remaining number of the recording medium stacked or information indicating that at least a predetermined number of sheets are remained. Further, the phrase “irrespective of the presence or absence” implies that the information is outputted when the recording medium is absent or even before using up the recording medium.

The electronic information includes information to be displayed on a display part provided in the image forming apparatus or on a display of a computer connected with the image forming apparatus.

A method of operating an image forming apparatus according to the present invention, includes: receiving an image forming command; determining whether or not a residual amount of a recording medium is sufficient enough to complete image formation in response to the image forming command; and outputting when applicable, information indicating that the residual amount of the recording medium is not sufficient enough to complete the image formation. It is particularly preferable that the information is outputted on a screen of a computer connected to the image forming apparatus.

A program which is executed by a computer connected directly or via a network with an image forming apparatus according to the present invention, includes: obtaining information concerning a residual amount of a recording medium stacked in the image forming apparatus; and displaying the information on a screen of the computer. The information described here refers to, for example, information of a remaining number of the recording medium or information indicating that at least a predetermined number of sheets are remained. The information may of course be provided in a form of graphic or character expressed visually to a user. Note that the program may further include displaying the information for every image forming apparatus with respect to plural image forming apparatuses connected directly or indirectly with the computer.

A program according to another aspect of the present invention program includes: obtaining information concerning plural image forming apparatuses connected directly or indirectly with a computer; allocating tasks of image formation process to be executed by the plural image forming apparatuses in response to an image forming command from a user; and issuing an image formation starting command to each of the plural image forming apparatuses having an allocated task of the image formation process.

A residual amount detecting device for detecting the sheet number of the recording medium stacked in the recording medium stacking means according to the present invention, includes: two electrodes interposing the recording medium therebetween; high frequency voltage detecting means that detects the high frequency voltage flowing between the two electrodes; and sheet number detecting means that detects the sheet number of the recording medium stacked in the recording medium stacking means based on the high frequency voltage detected by the high frequency voltage detecting means.

One of the electrodes of the residual amount detecting device of the present invention is preferably provided on a claw for tightening up the recording medium at a constant pressure in the recording medium stacking means, whereas the other electrode is provided opposite thereto in the recording medium stacking means. The electrode having the claw in the residual amount detecting device of the present invention may be structured to linearly move close to or apart from the recording medium.

The sheet number detecting means of the residual amount detecting device of the present invention preferably includes: a high frequency voltage versus recording medium sheet number storage circuit capable of storing the sheet number of the recording medium with respect to the high frequency voltage; and a sheet number computing circuit that computes the sheet number of the recording medium from the high frequency voltage versus recording medium sheet number storage circuit based on the high frequency voltage detected by the high frequency voltage detecting circuit. In the high frequency voltage versus recording medium sheet number storage circuit of the sheet number detecting means, there is stored in advance sheet numbers of the recording medium with respect to high frequency voltages. In other words, when the high frequency voltage is small, the sheet number of the recording medium is stored as large, and when the high frequency voltage is large, the sheet number of the recording medium is stored as small. When the high frequency voltage is detected by the high frequency voltage detecting means, the sheet number computing circuit of the sheet number detecting means reads out the sheet number of the recording medium corresponding to the detected high frequency voltage, from the high frequency voltage versus recording medium sheet number storage circuit. As a result, the sheet number of the recording medium stacked in the recording medium stacking means is detected. The high frequency voltage versus recording medium sheet number storage circuit of the residual amount detecting device of the present invention stores the recording medium sheet numbers with respect to the high frequency voltage for every thickness of the recording medium. In the residual amount detecting device, the thickness of one sheet of the recording medium varies due to a material constituting the recording medium. In a case where the recording medium has a large thickness, the thickness of the recording medium as a whole becomes large for the same sheet number of the recording medium, and the interelectrode distance accordingly becomes large. Thus, the high frequency voltage detected by the high frequency voltage detecting means becomes small. On the other hand, In a case where the recording medium has a small thickness, the thickness of the recording medium as a whole becomes small for the same sheet number of the recording medium, and the interelectrode distance accordingly becomes small. Thus, the high frequency voltage detected by the high frequency voltage detecting means becomes large. In this way, even when the same high frequency voltage is detected by the high frequency voltage detecting means, the remaining number of the recording medium varies if the thickness of one sheet of the recording medium is different. To cope with that, the high frequency voltage versus recording medium sheet number storage circuit is adapted to store the recording medium sheet numbers with respect to the high frequency voltage for every thickness of the recording medium. Accordingly, it is possible to detect the exact remaining number of the recording medium in accordance with the thickness of the recording medium.

In a preferred mode, the residual amount detecting device of the present invention may be provided with recording medium sheet number display means that displays the sheet number of the recording medium stacked in the recording medium stacking means. The residual amount detecting device of the present invention includes warning means that issues as needed a warning that the sheet number of the recording medium stacked in the recording medium stacking means is equal to or less than a predetermined sheet number.

An image forming apparatus according to the present invention includes: recording medium stacking means that stacks a recording medium therein; residual amount detecting device that detects the sheet number of the recording medium stacked in the recording medium stacking means; convey means that conveys the recording medium from the recording medium stacking means; and image formation means that forms an image on the recording medium conveyed by the convey means.

The image forming apparatus of the present invention further includes means that issues as appropriate a warning that the sheet number of the recording medium stacked in the recording medium stacking means is equal to or less than a predetermined sheet number, and stops the conveyance of the recording medium.

According to another aspect of the present invention, there is provided an information detecting apparatus for detecting information of presence or absence of a recording medium, including; external force applying means that applies an external force to a recording medium group in a thickness direction thereof; and external force detecting means that detects the external force applied to the recording medium group, in which the external force detecting means is disposed such that the recording medium group is set in a position between the external force applying means and the external force detecting means. As described above, before the recording medium stacked in the recording medium is used in its entirety, it is exceedingly preferable to detect information concerning the residual amount thereof. The presence or absence of the recording medium may of course be detected by using the above-mentioned external force applying means and external force detecting means. For example, if a signal in a case of the absence of the recording medium is stored in advance, and a signal from the detecting device becomes the same as that stored in advance, then information can be obtained indicating that the recording medium is used up.

### BRIEF DESCRIPTION OF THE DRAWINGS

FIG. 1 is a diagram illustrative of the present invention;

FIG. 2 is a diagram illustrative of the present invention;

FIG. 3 shows a sequence illustrative of the present invention;

FIG. 4 is a diagram illustrative of an embodiment of the present invention;

FIG. 5 is a graph schematically showing the relation between the residual amount of a recording medium and a high frequency voltage;

FIG. 6 is a schematic diagram showing the relation between a residual amount detecting device and a peripheral circuit diagram; and

FIG. 7 is a schematic diagram of an inkjet printer provided with a recording medium residual amount detecting device.

### DESCRIPTION OF THE PREFERRED EMBODIMENTS

(First Embodiment Mode: Recording Medium Residual Amount Detecting Device)

Referring to FIG. 1, a recording medium residual amount detecting device according to a first embodiment mode of the present invention will be described. In the drawing, a recording medium group 11 is located between external force applying means 1012 and external force detecting means 1010.

With this structure, the external force detecting means 1010 can detect signals in accordance with the residual amount of a recording medium. The recording medium group used in this specification is a concept including a case of a single sheet in addition to a case of plural sheets of course.

The external force includes a voltage, a vibration, and an impact, applied from the outside to the recording medium group. It is needless to mention that they may be used in combination to produce the external force. In FIG. 1, the external force applying means 1012 is provided only in an end region of the recording medium group 11. However, the external force applying means 1012 may of course be provided so as to cover the entire surface or provided across the entire width thereof. This point is also applicable to the external force detecting means 1010. Further, it is allowable to provide plural external force applying means and plural external force detecting means. As far as the external force can be applied or the external force can be detected, another member may be interposed between the external force applying means (or detecting means) and recording medium group. Hereinafter, a description will be given concerning the external force used in this embodiment mode.

In a case where a voltage is applied as the external force, the external force applying means 1012 and the external force detecting means 1010 are each composed of an electrode in contact with the recording medium group 11. Then, a voltage having a predetermined frequency is applied between the electrodes. The predetermined frequency is a frequency having on the order of several kHz to 500 kHz for instance. The interelectrode distance varies depending on the amount of the recording medium group. To be specific, as the amount (the remaining number) of the recording medium decreases, the interelectrode distance becomes smaller. Thus, a voltage to be detected by the detecting means becomes larger.

The structure may be preferable such that one of the external force applying means and the external force detecting means functioning as electrodes is fixed and the other is pressed against the recording medium group by a spring or the like, or such that the external force applying means and the external force detecting means are both pressed against the recording medium group. It should be noted here that if employing the structure of causing at least one of the means to be pressed against the recording medium group, it is preferable that the external force applying means and the external force detecting means are physically separated from each other.

As the external force, a voltage having a constant value (fixed voltage) may be used instead of the voltage having the predetermined frequency. The remaining number of the recording medium may be detected by using the two electrodes described above based on the change in capacitance caused by the change in remaining number thereof. In other words, any phenomenon can be utilized in which the interelectrode distance is changed according to the remaining number of the recording medium.

In a case where a vibration is applied as the external force, the external force applying means 1012 and the external force detecting means 1010 are each composed of a piezoelectric element such as a PZT. When a voltage having a predetermined frequency is applied to the external force applying means, the vibration is propagated from the surface of the recording medium group 11. Then, the vibration propagated in the thickness direction of the recording medium group is detected by the piezoelectric element functioning as a detecting part. In this case also, any phenomenon can be utilized in which the intensity of vibration to be detected by the detecting part is changed according to the amount of the recording medium group. Instead of applying the vibration as the external force, an impact may be applied. Specifically, the surface of the recording medium group is tapped by the external force applying means 1012, or the surface of the recording medium group is pressed against the external force applying means 1012. For a more convenient method, an impact member is dropped from a location at a constant height with respect to the bottom surface of the recording medium group.

The external force is described so far in detail. When the external force is applied and then detected, it is preferable that the recording medium group is at rest in view of reducing the unnecessary noise.

If the recording medium group is continuously or continually applied with the external force, which is then detected, it is possible to find a time when one sheet of the recording medium begins to be conveyed from a stack part of the recording medium group for instance.

In the recording medium residual amount detecting device described above, information concerning the residual amount of the recording medium group can be detected by comparing a signal which is stored in advance in a storage circuit corresponding to the residual amount, with a signal detected by the external force detecting means.

The information concerning the residual amount may be information of the actual remaining number of the recording medium or information indicating that the remaining number is equal to or more than a predetermined number.

In the early stage of the recording medium residual amount detecting device brought into service, first, it is preferable to find which kind of signals to be detected when a predetermined sheets of the recording medium are stacked.

The recording medium residual amount detecting device may further be provided with warning means that issues as occasion arises a warning that the remaining number of the recording medium group is equal to or less than a predetermined number.

According to this embodiment mode, it is possible to detect the residual amount of the recording medium group in a state of being stacked. In a container in which the recording medium group is stacked, the residual amount of the recording medium group can be detected while the recording medium group is at rest. To be more specific, the entire recording medium group may completely be at rest (in a state where the group is not conveyed at all), or a recording medium on the surface side among the recording medium group may be in the course of being conveyed. In a case where the detection is performed during a recording medium on the surface side among the recording medium group is being conveyed, the one recording medium being conveyed may be included or excluded when the residual amount is detected.

(Second Embodiment Mode: Image Forming Apparatus Having Residual Amount Detecting Device Mounted Thereon)

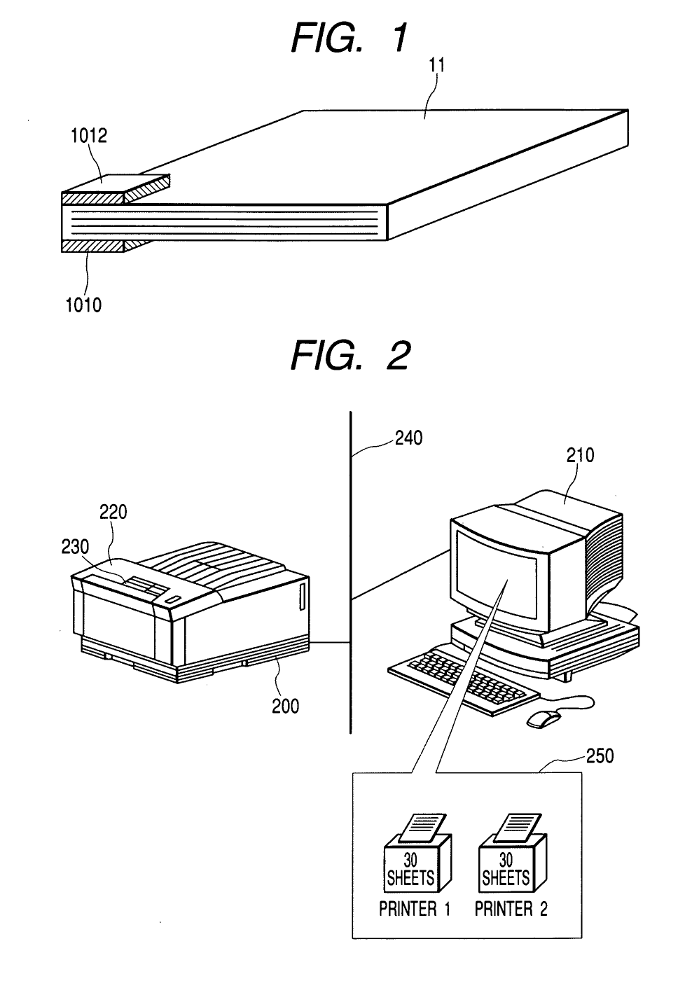

A second embodiment mode of the present invention will be described with reference to FIG. 2. Reference numeral 220 denotes an image forming apparatus schematically shown in a perspective view. Reference numeral 200 denotes stacking means of a recording medium group. The stacking means 200 has mounted thereon a residual amount detecting device capable of detecting information concerning the residual amount of a recording medium group irrespective of the presence or absence of the recording medium group, which is described in the first embodiment mode, for instance.

The information concerning the residual amount includes information of the actual remaining number of the recording medium, information indicating that the remaining number is equal to or more than a predetermined number, and information indicating that the recording medium falls short to complete printing instructed by a user. These information can be displayed on an information display part (denoted by reference numeral 230 in FIG. 2) which is actually provided in the image forming apparatus or be outputted by means of light or warning sound such as buzzer. Such information may of course be displayed on a screen of a computer connected directly or via a network with the image forming apparatus.

A specific example of sequences applicable to this embodiment mode is shown here.

As shown in FIG. 2, in this specific example, a printer serving as the image forming apparatus 220 is in a state of being connected via a network 240 with a computer 210 used by a user. FIG. 3 shows the specific sequence example.

First, an image forming command is sent to the image forming apparatus 220 (S1). The user may directly send such a command to the image forming apparatus or indirectly send the command from the screen of the computer 210 connected with the image forming apparatus via the network.

Next, it is determined whether or not the residual amount of the recording medium is sufficient to complete instructed image formation by using a detection signal from the recording medium residual amount detecting device mounted on the image forming apparatus (S2). The determination may be performed in the image forming apparatus or in the computer 210 connected directly or indirectly with the image forming apparatus. During image formation in response to an image forming command having been sent in first by another user (previous command), if the above-mentioned detecting command is issued (subsequent command); it is also possible that the detection of the residual amount of the recording medium is not performed, and the residual amount of the recording medium previously detected and the number of the recording medium to be subjected to image formation in response to the previous command are taken into consideration to perform the determination of S2.

If it is determined that the instructed image formation can completely be performed, printing starts (S3-1). If the amount of the recording medium is not sufficient for the printing, information of insufficient recording medium is outputted (S3-2). Accordingly, the user becomes free from regular control of whether or not the recording medium is running short during the printing.

The user receiving the information of insufficient recording medium may replenish the recording medium and send a command for the start of image formation, or may send the command without replenishing the recording medium

According to another mode, a system is also applicable in which the residual amount of the recording medium is constantly detected to display the image formation allowable sheet number. The term “constantly” implies here that the detection may be performed continuously on a time base or performed intermittently at predetermined time intervals. In a case of displaying the image formation allowable sheet number, it suffices that the residual amount of the recording medium actually stacked in the image forming apparatus is displayed. However, in a case of having previously received an image forming command from another user, it is more preferable to display the amount of the recording medium found by subtracting by the sheet number thereof to be used in response to the image forming command. However, information may of course be displayed indicating “there are at least a predetermined number of sheets left” etc instead of displaying the exact remaining number.

If plural printers are usable through the network, it is preferable to display information of the respective printers concerning the image formation allowable sheet number etc along with icons for the printers on the screen. For example, icons denoted by reference numeral 250 are shown in FIG. 2. In this case, the user may select a printer as needed.

By use of information for each of plural printers concerning the image formation allowable sheet number etc (assuming that a first image forming apparatus (printer) has 30 sheets of the recording medium left, and a second image forming apparatus has 90 sheets left), the following system for example is enabled.

That is, when a user A issues a command of image formation for 100 sheets on a computer, the computer automatically takes into consideration the residual amount of the recording medium of each image forming apparatus, and sends a command of image formation for only 30 sheets to the first image forming apparatus and a command of image formation for the remaining 70 sheets to the second image forming apparatus. In such a case, through complementing the shortage of the recording medium among the plural image forming apparatuses, it becomes possible to perform image formation without replenishment of the recording medium. It is of course preferable to display information on a computer display on the user side, which indicates that 30 sheets are (or to be) printed by the first image forming apparatus and 70 sheets are (or to be) printed by the second image forming apparatus

A program executing the various modes (or systems) described above may be stored in the image forming apparatus or in the computer connected therewith via the network etc.

(Embodiment)

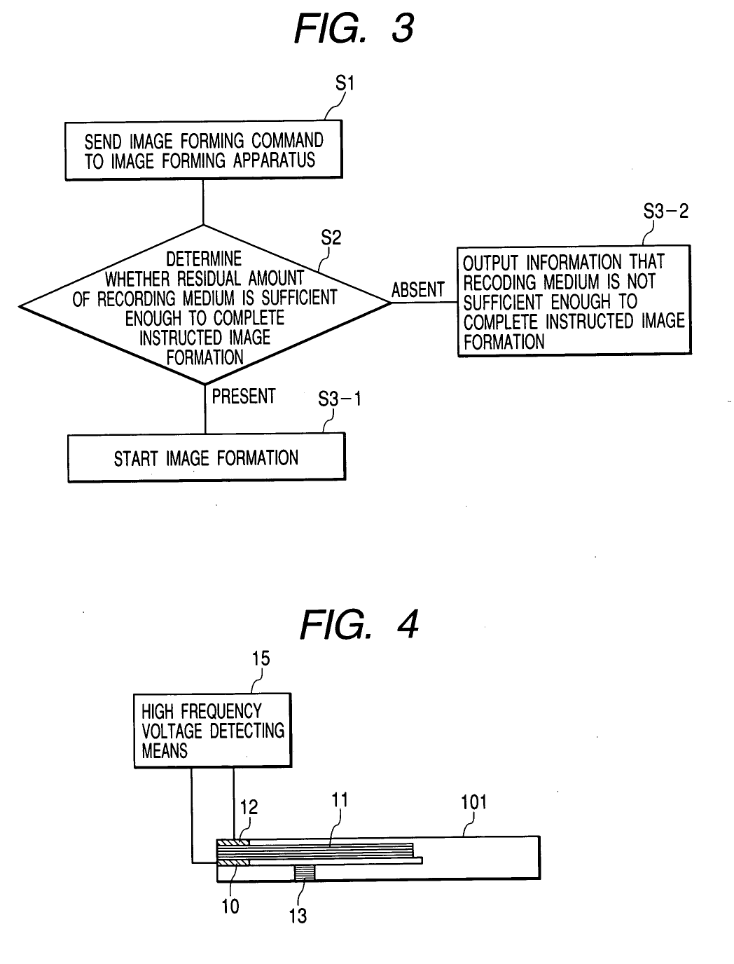

Hereinafter, an embodiment of the present invention will be described with reference to FIGS. 4 to 7.

Based on FIG. 7, an inkjet printer is described which is an example of an image forming apparatus provided with a recording medium residual amount detecting device.

The residual amount detecting device of the present invention can be provided not only to the inkjet printer but also to a copying machine, a facsimile, and a multifunctional machine having those functions.

An inkjet printer (IJP) 100 conveys a recording medium stacked in recording medium stacking means 101 by pickup rollers 102 and performs leading edge detection of the recording medium. After the detection, the IJP further conveys the recording medium to a printing position to form an image thereon, and then delivers it to recording medium delivery means 104.

Next, a residual amount detecting device will be described with reference to FIGS. 4 to 7.

In FIG. 4, a lower electrode 10 is mounted to the recording medium stacking means 101, and a spring 13 is adapted to tighten up a recording medium group 11 in the stacking means 101 toward an upper electrode 12. The two electrodes function as external force applying means and external force detecting means described in the present invention.

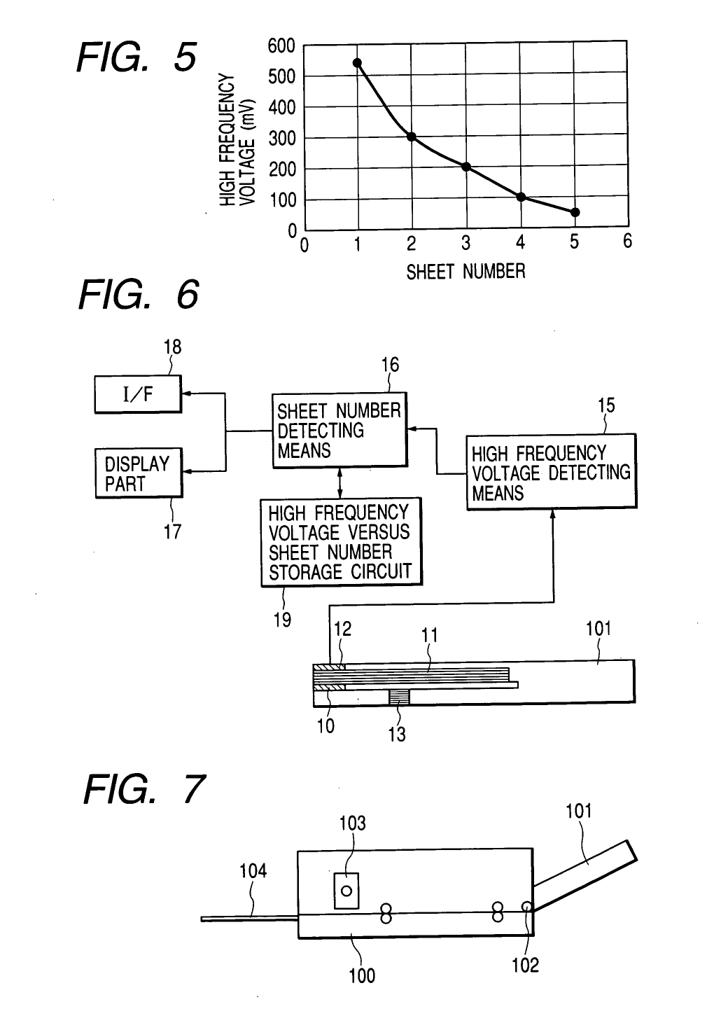

In this drawing, the lower electrode 10 and the upper electrode 12 are disposed opposing each other while interposing the recording medium 11 therebetween. In a state where a given amount of the recording medium 11 is stacked in the recording medium stacking means 101 as shown in the drawing, the interelectrode distance is large. In such a state, a small high frequency voltage is detected by high frequency voltage detecting means 15. On the other hand, as the remaining number of the recording medium 11 in the recording medium stacking means 101 decreases, the interelectrode distance becomes smaller effectively. As a result, the high frequency voltage detected by the high frequency voltage detecting means 15 increases. FIG. 5 is a graph showing the relation between the residual amount of the recording medium 11 and the detection voltage when applying a sine wave having a frequency of 137.6 kHz with a voltage value of 5 V between the two electrodes on the recording medium stacking means 101. As the recording medium 11, there is used plain paper such as New Printer Paper (CP-250: manufactured by Canon Inc.)

As shown in FIG. 5, when the recording medium 11 has 5 sheets, the high frequency voltage of about 56 mV is obtained. As the sheet number in the recording medium stacking means 101 decreases, the high frequency voltage increases. When only one sheet is left, the high frequency voltage of 545 mV is obtained. It should be noted here that when the recording medium 11 is used up from the recording medium stacking means 101, the high frequency voltage detecting means detects 5 V being applied between the electrodes. Thus, a state can be detected in which there is no recording medium 11 remained in the recording medium stacking means 101.

As shown in FIG. 6, the high frequency voltage detecting means 15 is connected to sheet number detecting means 16. The sheet number detecting means 16 reads out the sheet number of the recording medium 11 based on recording medium sheet numbers with respective to the high frequency voltage, which are stored in a high frequency voltage versus recording medium sheet number storage circuit 19, and then computes the current sheet number of the recording medium 11 stacked in the recording medium stacking means 101.

The high frequency voltage versus recording medium sheet number storage circuit 19 may be adapted to store the recording medium sheet numbers with respect to the high frequency voltage for every recording medium different in thickness due to the difference of a material constituting the recording medium 11. In this case, when the user specifies a kind of the recording medium by setting properties, it is possible to automatically compute the sheet number based on data of the recording medium sheet numbers with respect to the high frequency voltage in accordance with the kind of the recording medium 11.

With this structure, the residual amount detecting device estimates the sheet number of the recording medium 11 stacked in the recording medium stacking means 101 from the high frequency voltage. Although not shown in the drawings, a signal from the sheet number detecting means 16 is transmitted to a host device side via an interface 18 of the image forming apparatus. On the host device side, printing data is generated upon the reception of the signal, and then transferred to the image forming apparatus side.

The image forming apparatus receiving the printing data operates a printing head with a control circuit of an inkjet head to form an image on the recording medium 11. A display part 17 displays information when the sheet number of the recording medium 11 remained in the recording medium stacking means 101 is reduced to a predetermined sheet number.

Further, if a comparison operational circuit is provided to compare the processing sheet number instructed by the user with the remaining number from the sheet number detecting means 16, a warning can also be issued to the user that the processing sheet number is less than the remaining number. Furthermore, it is also possible to detect a situation where the recording medium 11 is absent in the recording medium stacking means 101. At this time, a warning can be given to the user, or it is possible to restrain the image forming apparatus from operating.

According to the present invention, it is possible to detect information concerning the residual amount of the recording medium even before using up the recording medium group stacked in the image forming apparatus.

In the image forming apparatus, in general, recording medium supply rollers rotate and if the recording medium is conveyed in accordance with the roller rotation to a sensor position within a given time, the sensor works to determine that the recording medium is “present”, thereby entering a image formation mode. In a case where the recording medium is not remained, the recording medium supply rollers idly rotate, no recording medium is conveyed to the sensor position with in the given time, it is determined that the recording medium is “absent”, and a warning sound or a warning message “there is no sheets left” or the like is given to the host device or the user. Therefore, the number of the recording medium is unknown to the host device and the user until the recording medium is used up. In a case of a network printer, in particular, the printer is set in a position far from the host device and the user in many cases. Thus, the user needs to go round the network printer to replenish the recording medium after the recording medium is completely used. However, according to this embodiment, it becomes possible to detect information concerning the residual amount of the recording medium before the recording medium runs out.

When the information cannot be obtained concerning the residual amount of the recording medium before it is used up, the recording medium supply rollers idly rotate due to no supply of the recording medium, degradation of the rollers due to contact or friction with separation pads is accordingly effected, and also shavings are produced. Therefore, to avoid the above situation, there is a need to use a material superior in durability for the supply rollers. In contrast, according to this embodiment, a degree of freedom increases to choose a material for components.

What is claimed is:

1. A recording medium residual amount detecting device for detecting information concerning a residual amount of recording medium, comprising:
external force applying means that applies an external force to a recording medium group in a thickness direction thereof; and
external force detector that detects the external force applied to the recording medium group,
wherein the external force detector is disposed such that the recording medium group is set in a position between the external force applying means and the external force detector.

2. A recording medium residual amount detecting device according to claim 1, wherein the external force applying means applies voltage, vibration or impact to the recording medium group.

3. A recording medium residual amount detecting device according to claim 2, wherein when voltage is used as the external force, the external force applying means and the external force detector are composed of a first electrode capable of being in contact with a front surface of the recording medium group and a second electrode capable of being in contact with a rear surface of the recording medium group, and wherein the recording medium residual amount detecting device further comprises voltage applying means that applies a voltage between the first electrode and the second electrode.

4. A recording medium residual amount detecting device according to claim 1, wherein the information concerning a residual amount of recording medium is detected by comparing a signal stored in advance in a storage circuit corresponding to a residual amount, with a signal detected by the external force detector.

5. A recording medium residual amount detecting device according to claim 1, wherein the information concerning a residual amount of recording medium is information indicating a remaining number of the recording medium stacked or indicating that at least a predetermined number of sheets are remained.

6. A recording medium residual amount detecting device according to claim 1, further comprising warning means that issues, when the remaining number of the recording medium is equal to or less than a predetermined value, a warning indicating that the remaining number is equal to or less than the predetermined value.

7. An image forming apparatus provided with the recording medium residual amount detecting device as set forth in claim 1 and recording medium stacking means for stacking a recording medium group.

8. An image forming apparatus comprising detector that detects information concerning a residual amount of recording medium stacked in the image forming apparatus, wherein the information is outputted as electronic information irrespective of presence or absence of the recording medium.

9. An image forming apparatus according to claim 8, wherein the information concerning a residual amount of recording medium comprises information indicating a remaining number of the recording medium stacked or indicating that at least a predetermined number of sheets are remained.

10. An image forming apparatus according to claim 8, wherein the detector comprises:
external force applying means that applies voltage, vibration or impact as an external force to a recording medium group in a thickness direction thereof; and
external force detector that detects the external force applied to the recording medium group, the external force detector being disposed such that the recording medium group is set in a position between the external force applying means and the external force detector.

11. An image forming apparatus according to claim 8, wherein the information is outputted irrespective of whether the recording medium is used up or before the recording medium is not used up.

12. An image forming apparatus according to claim 8, wherein the electronic information comprises information which is displayed on a display part provided in the image forming apparatus or on a display of a computer connected with the image forming apparatus.

13. An image forming apparatus adapted for executing a process comprising steps of:
receiving an image forming command;
determining whether or not a residual amount of recording medium is sufficient enough to complete image formation in response to the image forming command; and
outputting when applicable, information indicating that the residual amount of recording medium is not sufficient enough to complete the image formation.

14. An image forming apparatus according to claim 13, wherein the information is outputted on a screen of a computer connected to the image forming apparatus.

15. A program which is executed by a computer connected directly or via a network with an image forming apparatus, comprising steps of:
obtaining information concerning a residual amount of recording medium stacked in the image forming apparatus; and
displaying the information on a screen of the computer.

16. A program according to claim 15, wherein the information is information indicating a remaining number of the recording medium or information indicating that at least a predetermined number of sheets are remained.

17. A program according to claim 15, wherein the information is provided in a form of graphic or character expressed visually to a user.

18. A program according to claim 15, further comprising a step of displaying the information for every image forming apparatus with respect to plural image forming apparatuses connected directly or indirectly with the computer.

19. A program comprising steps of:
obtaining information concerning plural image forming apparatuses connected directly or indirectly with a computer;
allocating tasks of image formation process to be executed by the plural image forming apparatuses in response to an image forming command from a user; and
issuing an image formation starting command to each of the plural image forming apparatuses having an allocated task of the image formation process.

20. An information detecting apparatus for detecting information of presence or absence of recording medium, comprising;
external force applying means that applies an external force to a recording medium group in a thickness direction thereof; and
external force detecting means that detects the external force applied to the recording medium group,
wherein the external force detector is disposed such that the recording medium group is set in a position between the external force applying means and the external force detector.
